(19) United States
(12) Patent Application Publication
(10) Pub. No.: US 2026/0356310 A1
(43) Pub. Date: Nov. 12, 2026

(54) BUMPER ARRANGEMENT

(71) Applicant: BENTELER AUTOMOBILTECHNIK GMBH, Paderborn (DE)

(72) Inventors: Georg FROST, Steinheim (DE); Jin BINHUI, Shanghai (Municipality) (CN)

(21) Appl. No.: 19/655,283

(22) Filed: Apr. 22, 2026

(30) Foreign Application Priority Data
Apr. 23, 2025 (CN) 202510523406.6
Sep. 26, 2025 (CN) 202511394530.3

(51) Int. Cl. B60R 19/02; B60R 19/18; B60R 19/34

(52) U.S. Cl. CPC B60R 19/023; B60R 19/18; B60R 19/34; B60R 2019/1806

(57) ABSTRACT

A bumper arrangement for a motor vehicle has a main cross member and an auxiliary cross member arranged underneath relative to the motor vehicle vertical direction. The main cross member and the auxiliary cross member each have a course curved around the motor vehicle vertical direction. The main cross member and the auxiliary cross member are connected to one another via vertical webs. The main cross member, auxiliary cross member and webs are manufactured from a tailor welded blank from a steel material by press forming. The main cross member and the auxiliary cross member are formed in cross section as a hollow profile open on one side, and the bumper arrangement is coupled to the motor vehicle via crash boxes. The main cross member has a closing plate in sections, and the bumper arrangement has different strengths and/or wall thicknesses in sections.

### RELATED APPLICATIONS

The present application claims priority of Chinese Application Numbers 202510523406.6 filed Apr. 23, 2025, and 202511394530.3 filed Sep. 26, 2025, the disclosures of which are hereby incorporated by reference herein in their entirety.

### FIELD

The present disclosure relates to a bumper arrangement.

### BACKGROUND

Motor vehicles have bumper arrangements at the front or end side. In the event of a vehicle crash or a rear-end collision, or an impact against an object, two tasks are fulfilled by such bumper arrangement. Firstly, there is a cross member. The cross member has sufficient stiffness to prevent a corresponding object or a motor vehicle from penetrating too deeply into the front or end portion. Consequently, a point impact, for example on a pole, is transmitted by the cross member to a large part of the motor vehicle width.

A second task that is fulfilled by a bumper arrangement is the conversion of crash energy into deformation work and thereby a corresponding reduction in the impact energy. For this purpose, a respective cross member is coupled to the motor vehicle via crash boxes. or this purpose, the crash boxes are arranged relative to the motor vehicle transverse direction between a center region and an end portion of the cross member, consequently relative to the motor vehicle width respectively between a third and a quarter with the length in the outer region of the cross member. The crash boxes are then mostly coupled to longitudinal members or to a front-side end of the motor vehicle. In the event of an impact with an opposing vehicle with full or partial overlap (small overlap), the crash boxes fold, for example, like an accordion, and thus convert crash energy into deformation work. In contrast, a high degree of energy is already dissipated by a targeted strong deformation of the cross member itself at the beginning of a central pole impact before further energy is dissipated uncritically for the occupants by targeted buckling of the crash boxes and, if necessary, the longitudinal members.

### SUMMARY

The object of the present disclosure is to provide bumper arrangement which has improved crash performance, and can be adjusted specifically to different crash requirements in production and can simultaneously be manufactured cost-effectively.

The bumper arrangement according to the present disclosure for a motor vehicle is manufactured from steel material. A press forming process is used for this purpose. Thus, a blank is first provided, which is then inserted into a press forming tool and is formed by a press forming process, for example, a deep-drawing process. Here, hot forming and press hardening technology is used at least in sections. That is, strength properties with tensile strengths Rm greater than 1,350 MPa can be set at least partially in the material structure. For this purpose, the blank is heated at least in regions to a temperature above the austenitization temperature with above AC3 temperature. Depending on the steel alloy used, this corresponds to a temperature of over 800 °C, or over 900 °C. A hardenable steel material is used as the steel alloy. For example, 22MnB5. Subsequently, the blank is formed in the hot state and cooled so rapidly that the high-strength properties are specifically set.

In the bumper arrangement according to the present disclosure, a tailor welded blank is used as the blank. This is a blank that is first provided from different sheet metal pieces or blanks welded together. According to the present disclosure, these are welded together as a butt joint. This means that the respective end faces of the individual blanks used to manufacture the tailor welded blank lie against one another. This results in a so-called butt joint. These end faces lying against one another are then welded together. Laser welding is used for this purpose. Through the butt joint welding, low use of material and optionally only a one-sided wall thickness jump is achieved with advantages in the press hardening process through better system contact and thereby a shorter cooling rate. At the same time, a high quality of the manufactured weld seam can be achieved, so that in the event of a crash, a secure connection of the individual blank parts results. By using a tailor welded blank, a corresponding wall thickness can already be used in the raw part, i.e., before the press forming process, adapted to the crash properties to be fulfilled. Wall thicknesses between 0.5 mm and 4 mm, from 1 mm to 3 mm, are used. Alternatively or additionally, different strengths can be set. For example, in the regions in which no increase in strength is to occur, a steel with lower steel quality, for example, a non-hot-formable steel, can be used. This in turn achieves material or cost savings in the steel types used. Even in the later hot forming and press hardening process, the blank can be heated completely. Due to the fact that in the regions that are not intended to achieve increased strength, no hardenable properties of the steel alloy used are present, there is no need to work with complex partial heating or cooling processes. The entire tailor welded blank can thus be heated, hot formed and press hardened. In the regions in which no hardenable properties are then present, the steel is also not hardened and thus has softer or more ductile properties. In at least one embodiment of the present disclosure, a tensile strength Rm below 1,000 MPa is then present here, a tensile strength between 500 MPa and 1,000 MPa, or between 500 MPa and 800 MPa.

The butt joint is formed at least at one, two, or several and at all connection points of the tailor welded blank, it is then laser-welded.

However, in addition, in at least one region, in two regions, an overlap and a welding in the region of the overlap can occur, consequently no butt joint in the region of the overlap. In at least one embodiment of the present disclosure, the overlap is formed in the crash box attachment portion. As a result, the main cross member is reinforced in this region by the double layer. The area of the overlap is thus more than 10 cm². The area of the overlap, i.e., one overlap, is more than 10 cm², more than 50 cm², 100 cm² to 200 cm². In the region of the overlap, welding can be performed circumferentially at least in sections. However, the region of the overlap can also be joined in another way, for example, by adhesive bonding and/or riveting. The bumper arrangement itself now has a main cross member and an auxiliary cross member arranged underneath relative to the motor vehicle vertical direction. The main cross member and the auxiliary cross member are thus arranged offset to one another relative to the height in the motor vehicle vertical direction.

The auxiliary cross member terminates a lower load path towards the front via vehicle sills and front axle carrier or subframe and, if necessary, lower crash boxes or longitudinal members.

The main cross member and the auxiliary cross member each have a course curved around the motor vehicle vertical direction. The main cross member and auxiliary cross member can have radii of curvature that are different from one another. The radius of curvature can change over the longitudinal course of both main cross member and auxiliary cross member. The crash boxes are coupled to the main cross member.

The main cross member and the auxiliary cross member are connected to one another via vertical webs. At least vertical webs are arranged relative to the motor vehicle transverse direction in an outer end portion. Here, the advantage results in that these vertical webs are then arranged relative to the motor vehicle transverse direction in front of a wheel located behind them. In at least one embodiment of the present disclosure, the bumper arrangement is arranged in the front region of the motor vehicle. This results in an additional load path. If a frontal impact were to take place, the webs would hit the wheel located behind them and thus provide a corresponding additional load path at the wheel and either first the wheel suspension, provided the wheel is then pushed against a sill located behind it. In at least one embodiment of the present disclosure, however, at least four webs can also be formed. Two webs are then arranged in the region of the crash boxes, two further webs in the outer end portion, in front of a respective wheel. The webs can be formed running substantially vertically oriented. In at least one embodiment of the present disclosure, the coupling points between the respective web and main cross member as well as the respective web and auxiliary cross member are formed in the butt joint, as already mentioned at the beginning.

The bumper arrangement is then manufactured by means of press forming. In at least one embodiment of the present disclosure, the raw part is first provided as tailor welded blank. The entire tailor welded blank is already adapted to the geometry of the bumper arrangement to be achieved. Due to the configuration with the main cross member, the auxiliary cross member and the webs, however, the scrap material can be reduced as far as possible. The tailor welded blank is then inserted in one piece, i.e., the one tailor welded blank into a press forming tool and formed into the bumper arrangement. In at least one embodiment of the present disclosure, the main cross member and auxiliary cross member are formed in cross section as a hollow profile open on one side. In at least one embodiment of the present disclosure, these can be formed C-shaped, U-shaped or also hat-shaped in cross section at least in sections, completely over their respective longitudinal course. The webs can also be formed C-shaped, U-shaped or hat-shaped in their cross section. In at least one embodiment of the present disclosure, the open side of this hollow profile open on one side is arranged open pointing in the motor vehicle longitudinal direction or away from the vehicle or pointing towards the front relative to the main direction of travel.

Alternatively, only the main cross member and outer webs are formed open pointing away from the vehicle and inner webs and the auxiliary cross member are open towards the vehicle.

The main cross member furthermore has a closing plate at least in sections. By means of the closing plate, it is thus possible to help influence the crash properties in that the closing plate counteracts the opening up of the open hollow profile of the main cross member and, if necessary, the auxiliary cross member and increases the profile rigidity. In at least one embodiment of the present disclosure, the closing plate is arranged centrally relative to the motor vehicle transverse direction and extends over a longitudinal course of the main cross member of at least 20%, more than 30%, and more than 40%. In at least one embodiment of the present disclosure, the closing plate can extend over the entire longitudinal course, consequently over the entire width of the main cross member.

Furthermore, the bumper arrangement furthermore has different strengths in sections. Strength is to be understood as the tensile strength Rm. Alternatively or additionally to the different strengths, the bumper arrangement can have different wall thicknesses in sections. This makes it possible to form an adaptation of the wall thicknesses and/or strengths specifically to the crash properties to be fulfilled. For example, the main cross member can have an increased strength or increased wall thickness compared to, for example, the auxiliary cross member and/or the webs.

Due to the increased strength and/or wall thickness as well as also the closing plate, it is thus possible to specifically set the crash properties to be fulfilled. In at least one embodiment of the present disclosure, the main cross member is equipped with an increased strength and/or increased wall thickness in an attachment portion, which extends from crash box to crash box, and at least in sections over the longitudinal course a closing plate. This results in a high rigidity in a central portion of the main cross member.

In at least one embodiment of the present disclosure, the main cross member and/or the auxiliary cross member has two trigger beads in an attachment portion between the crash boxes on a front side or front wall or a rear side or rear wall. A respective trigger bead is then arranged from a center of the main cross member relative to the motor vehicle transverse direction to a crash box. In the case of the front wall, a trigger bead, hereinafter also called bead, is arranged in a length range between 0.008 and 0.38 times the length of the main cross member, seen from a center of the main cross member to the crash box. The bead in the front wall, i.e., in the flange of the hat profile, has a depth relative to the depth of the main cross member in the same cross section of 1/10 to ⅓, ⅛ to ¼. The width can be between a few millimeters to a few centimeters, but at most 1/10 of the length of the main cross member between the crash boxes. In a front view of the bumper arrangement, a trigger bead is thus formed respectively on the left side and right side relative to the center. The main cross member is initially formed resistant to bending here by measures described above. However, the trigger beads make it possible to reduce initial crash energy in the case of, for example, a frontal impact or a pole test, since the main cross member yields in itself, without however losing its overall rigidity. In the case of a bead in the rear wall (concavity), compared to the front wall bead, this is a relatively wide bead which runs over the entire rear wall height and tapers the cross section of the hat profile accordingly. The bead has a depth relative to the depth of the main cross member in the same cross section of 1/10 to ½, ⅕ to ⅓. The width can be between a few centimeters up to at most ⅕ of the length of the main cross member between the crash boxes. The rear wall bead is formed respectively in a longitudinal portion between 0.3 and 0.45 times the length of the cross member, seen from the center of the cross member to the crash box. In at least one embodiment of the present disclosure, in the case of a bead provided only on one flange side, this can interact synergistically with the rear wall bead. Alternatively, the rear wall bead can be omitted completely or be less pronounced, if beads are already arranged at the front in both flanges of the main cross member.

The increased strengths are formed at a tensile strength Rm greater than 1,350 MPa, or greater than 1,500 MPa. However, the tensile strength Rm should not exceed 2,500 MPa. In the relatively unhardened or soft regions, the tensile strength is formed between 500 MPa and 1,000 MPa.

Optionally in addition, the auxiliary cross member and/or the webs can also be closed by a closing plate. The closing plate for the auxiliary cross member is formed in sections. In at least one embodiment of the present disclosure, the closing plate can also cover the entire length of the auxiliary cross member.

In the case of, for example, four webs, also only two webs can be closed by a closing plate.

A total closing plate can also be arranged, which closes the main cross member, the auxiliary cross member and the web from behind.

In at least one embodiment of the present disclosure, in the case of closing plates, the main cross member, the webs and/or the auxiliary cross member are themselves formed hat-shaped in cross section. Flanges thus project on the outside, which are welded to the closing plate. The closing plate is then welded to the main cross member or webs and auxiliary cross member after the press forming process.

In the course of manufacturing efficiency, the closing plate is manufactured from scrap regions, which are provided for the individual blanks for providing the tailor welded blank.

For further efficiency reasons, the closing plate is then formed in one press stroke with the tailor welded blank. However, the closing plate here lies next to the tailor welded blank and does not form a double layer during hot forming. The closing plate itself can also be formed hot-formed and press-hardened.

In at least one embodiment of the present disclosure, the main cross member has radii in its cross section that are different from one another. In at least one embodiment of the present disclosure, this radius relates to the transition of the main cross member in cross section from the rear web to the leg. In a longitudinal portion at the crash boxes, this radius of the hat profile is formed smaller, consequently in an attachment portion of the crash boxes. The cross section tends more towards a rectangular cross section in the transition from rear web of the hat profile to the legs respectively adjoining it. The main cross member itself is thus formed more right-angled or rectangular in cross section. By this measure, the connection point of the crash box is improved or enlarged. This results in a lower risk of cracking in, for example, a central pole crash, both in the joint connection to the crash box and in the center of the cross member itself. In the longitudinal portion between the crash boxes, consequently in a crash box attachment portion, the radius between rear web and legs is formed larger. The cross section of the hat profile in the region of the leg and the web is thus formed rounder or more curved.

The difference between the radius in the crash box attachment portion of transition from web to leg and the radius in the longitudinal portion between the crash boxes, but in the center of the cross member, should be 50%. The radius between the crash boxes is at least 50%, or at least 100% up to 400% larger than the radius in the crash box attachment portion.

A central longitudinal portion of the cross member extends in the motor vehicle transverse direction over at least 300 mm, or 350 mm. However, the central longitudinal portion should not be longer than 1,000 mm, and less than 500 mm.

The radius in the region of the crash box attachment is 3 mm to 6 mm, or 4 mm to 5 mm. In the central longitudinal portion, i.e., between the crash boxes, the radius can be between 10 mm and 30 mm, between 11 mm and 20 mm, between 14 mm and 16 mm, or approx. 15 mm. The radius is to be understood as the transition between lower leg and web.

In at least one embodiment of the present disclosure, the main cross member has a curvature around the motor vehicle vertical direction, wherein the radius of curvature changes over the longitudinal course of the main cross member, the radius of curvature is smaller in a central portion between the crash boxes and larger in the region of the crash box attachment. In the end portions, the radius of curvature can in turn become smaller, consequently there is a stronger curvature. As a result, a substantially straighter, not so strongly curved surface can be provided in the region of the crash box attachment. This has an advantageous effect on the energy transmission in the event of a crash. In the central portion, consequently between the crash box attachments, the curvature is formed stronger, i.e., the radius of curvature is smaller. As a result, the cross member is more strongly bent in this region.

### BRIEF DESCRIPTION OF THE DRAWINGS

Further advantages, features and properties and aspects of the present invention are the subject of the following description. Design variants are represented in the schematic figures. The design variants described above as well as the figures can be combined with one another as desired also in individual features, without departing from the disclosure content of the present disclosure. In the drawings:

FIG. 1 shows a perspective view of bumper arrangement according to at least one embodiment of the present disclosure,

FIG. 2A and FIG. 2B show a blank before forming in the case of FIG. 2A and the formed bumper in front view in the case of FIG. 2B according to at least one embodiment of the present disclosure,

FIG. 3A and FIG. 3B show an alternative design variant to FIG. 2A and FIG. 2B according to at least one embodiment of the present disclosure,

FIG. 4A and FIG. 4B show an alternative design variant to FIG. 2A and FIG. 2B according to at least one embodiment of the present disclosure,

FIG. 5 and FIG. 6 show an alternative design variant to FIG. 2A and FIG. 2B according to at least one embodiment of the present disclosure,

FIG. 7 shows an alternative design variant to a bumper according to at least one embodiment of the present disclosure,

FIG. 8 shows a plan view of bumper arrangement according to at least one embodiment of the present disclosure,

FIG. 9 shows a plan view analogous to FIG. 8 according to at least one embodiment of the present disclosure,

FIG. 10 shows an alternative design variant according to at least one embodiment of the present disclosure,

FIG. 11 shows further end view of bumper arrangement according to at least one embodiment of the present disclosure,

FIG. 12A and FIG. 12B show an end view of an alternative design variant according to at least one embodiment of the present disclosure,

FIG. 13A and FIG. 13B show an analogous design variant to FIG. 12A and FIG. 12B according to at least one embodiment of the present disclosure,

FIG. 14A and FIG. 14B show an analogous design variant to FIG. 12A and FIG. 12B according to at least one embodiment of the present disclosure,

FIG. 15A and FIG. 15B shows an alternative design variant according to at least one embodiment of the present disclosure, and

FIG. 16A and FIG. 16B shows an independent inventive idea of a cross member with overlap according to at least one embodiment of the present disclosure. This can be combined with the aforementioned design variants.

### DETAILED DESCRIPTION

In the figures, the same reference numerals are used for identical or similar components, even if a repeated description or representation is omitted for reasons of simplification.

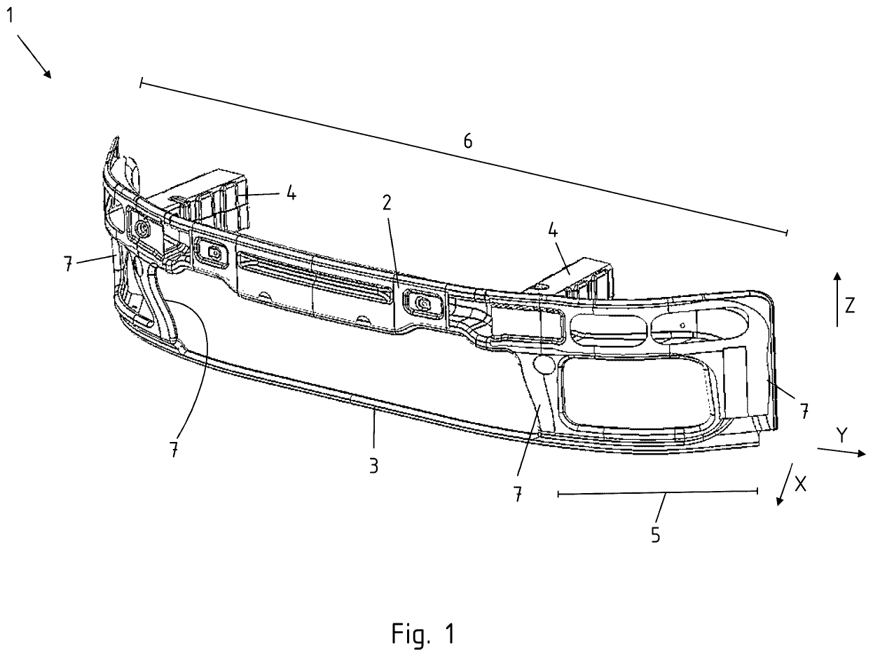

FIG. 1 shows a bumper arrangement 1 according to the present disclosure for mounting on a motor vehicle not shown in detail. The bumper arrangement 1 has a main cross member 2 located at the top relative to the motor vehicle vertical direction Z as well as an auxiliary cross member 3 located underneath. The main cross member 2 and the auxiliary cross member 3 are thus arranged offset to one another in the motor vehicle vertical direction Z. The bumper arrangement 1 furthermore has crash boxes 4. In this design variant, the crash boxes 4 are coupled to the main cross member 2. Relative to the motor vehicle longitudinal direction X, crash boxes 4 are arranged behind the main cross member 2. Relative to the motor vehicle transverse direction Y, an outer end portion 5 projects respectively via the crash boxes 4. The end portion 5 can have, for example, between 10 and 30% of the entire length or width of the main cross member 2. In the case of a rear cross member arrangement, however, the end portion can also be omitted.

The main cross member 2 and the auxiliary cross member 3 are connected to one another respectively via webs 7. The webs 7 are formed substantially vertically oriented, consequently the course of webs 7 is oriented in the motor vehicle vertical direction Z. Provided here are a total of four webs 7. Two webs 7 are arranged in the region of crash boxes 4. Furthermore, two webs 7 are arranged on the outside, in outer end portion 5. A motor vehicle wheel not shown in detail can then be located behind outer webs 7 in motor vehicle longitudinal direction X. If the bumper assembly 1 were to be deformed backwards in the motor vehicle longitudinal direction X in the event of a crash, on the one hand the crash boxes 4 would fold and thereby dissipate crash energy. Furthermore, the outer webs 7 would hit a wheel located behind them and thus provide an additional load path.

The main cross member 2 and the auxiliary cross member 3 each have a curvature. The curvature is formed oriented around the motor vehicle vertical direction Z. The curvature is not constant. The radius of curvature differs over the longitudinal course of the main cross member 2 and also of the auxiliary cross member 3. The curvatures of the main cross member 2 and the auxiliary cross member 3 can be formed identical or similar. However, the curvatures can also be formed different from one another. In this design variant, the auxiliary cross member 3 is arranged in a central portion, i.e. between the crash boxes 4, offset to the rear relative to the motor vehicle longitudinal direction X compared to the main cross member 2.

Various openings can be present in the main cross member 2 and in the auxiliary cross member 3. For example, to fasten a towing sleeve or to place sensors as well as also for weight saving.

The end portion 5 is formed ring-shaped. The ring shape results from the main cross member 2 in the upper region, the auxiliary cross member 3 in the lower region as well as the two webs 7. Such a ring-shaped end portion has an advantageous effect on a crash scenario.

The auxiliary cross member 3 is additionally fixed to the vehicle via the crash boxes 4 or the lower longitudinal members (not shown).

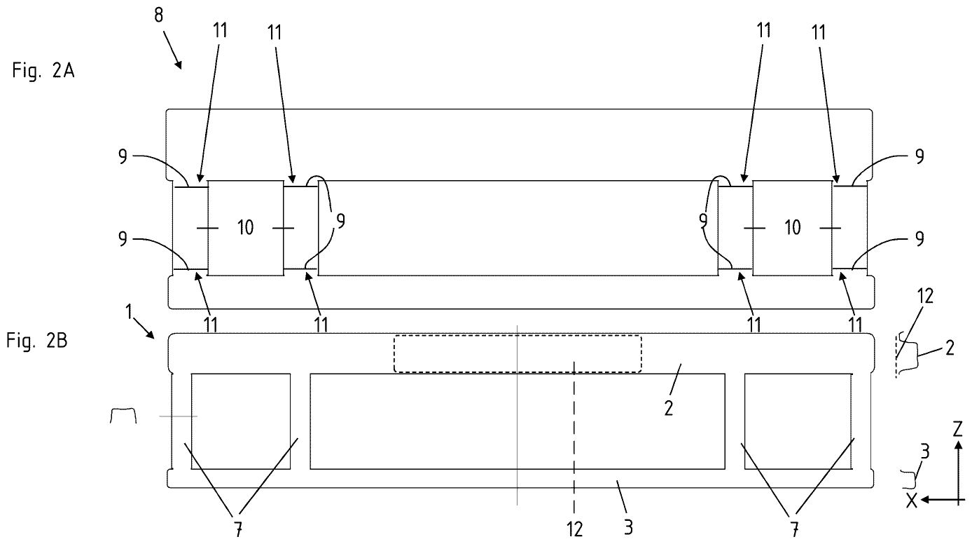

FIG. 2A shows the tailor welded blank 8 before press forming to manufacture the bumper arrangement 1, which is shown in FIG. 2B in front view as well as 2 cross-sectional views, and the two respective cross-sectional views are shown. First, according to FIG. 2A, the tailor welded blank 8 is provided. This is initially formed larger in its outer dimensions relative to the later motor vehicle vertical Z and motor vehicle longitudinal direction X than the later main cross member 2, the auxiliary cross member 3 as well as the connecting webs 7. This is due to the fact that the blank 8 is then formed by means of a press forming process and thus the outer dimensions decrease in plan view. At connection points 9 between the later main cross member 2 and the webs 7, the tailor welded blank 8 is formed in a butt joint. Consequently, the end faces lie against one another in this region. In the region of the connection of a respective web plate 10, a respective extension or projection 11 is formed both on the later main cross member 2 and on the later auxiliary cross member 3. It has proven to be advantageous if, after forming, the region of the later weld seam has a certain projection 11 compared to the main cross member 2. No weakening or a negligible weakening due to this geometric configuration of the projection 11 or extension is to be recorded here in the region of the weld seam.

In FIG. 2B, the later bumper arrangement 1 is then represented in end view, consequently after press forming. The sectional views show that both in the region of the webs 7 a U-shaped cross section is formed on the left relative to the image plane. Furthermore, a section is drawn in the central region. The sectional views are then represented in FIG. 2B on the right relative to the image plane. The cross section of the main cross member 2 is formed substantially hat-shaped. Furthermore, a closing plate 12 is provided. Relative to the motor vehicle longitudinal direction X, the U-shaped or hat-shaped cross-sectional profiles of the main cross member 2 and the auxiliary cross member 3 as well as also of the webs 7 are formed open towards the front, consequently open in the direction of travel. The closing plate 12 is thus arranged towards the front in the direction of travel. According to FIG. 2B, the closing plate 12 extends over a central section relative to the total length of the main cross member 2 over approx. 20 to 50%.

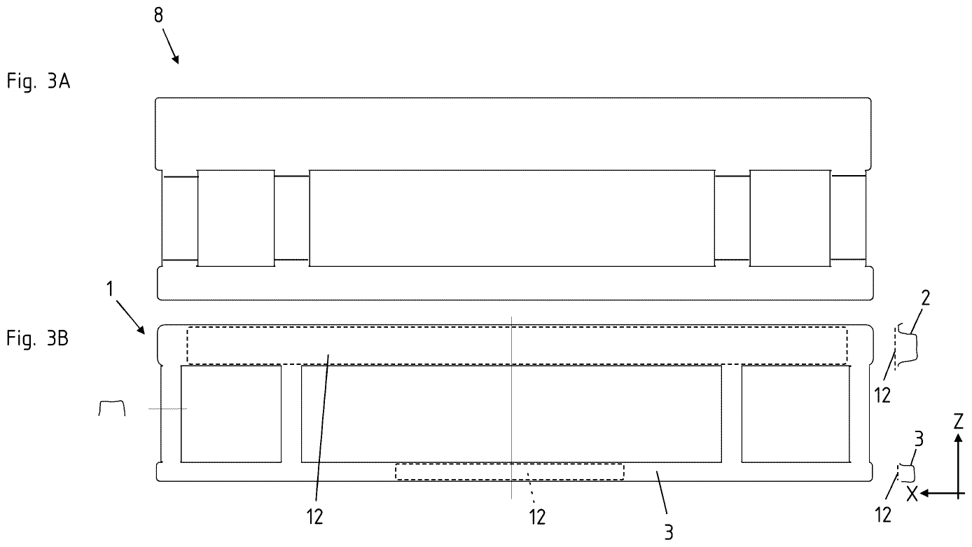

FIG. 3A and FIG. 3B show an alternative design variant to FIG. 2A and FIG. 2B. This differs substantially in that the closing plate 12 of the main cross member 2 extends substantially over the entire width, shown here however over approx. 90 to 95% of the total length of the main cross member 2. Furthermore, a further closing plate 12 is arranged in the region of auxiliary cross member 3. The closing plate 12 in the region of the auxiliary cross member 3 is arranged centrally and extends over a length 6 of approx. 20 to 50% of the auxiliary cross member 3.

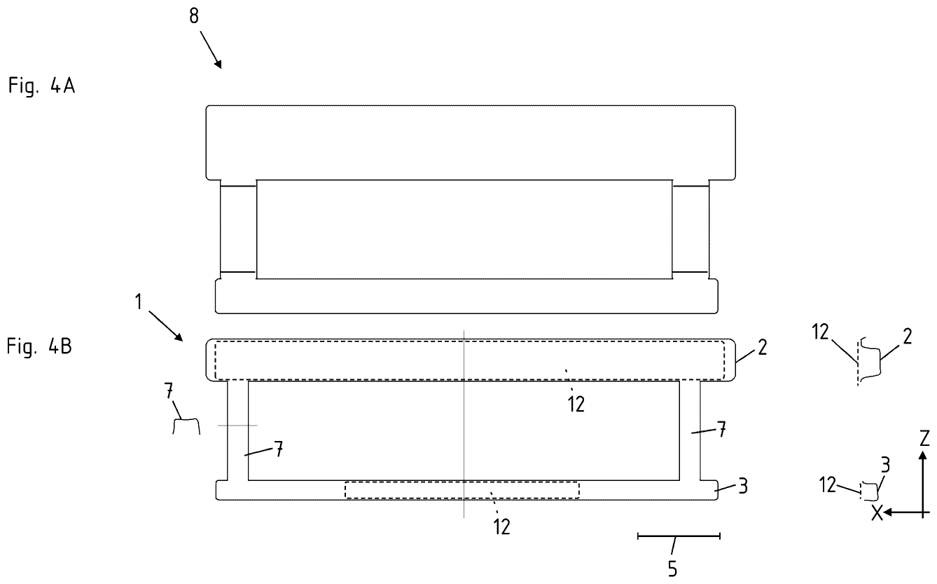

FIG. 4A and FIG. 4B show an alternative design variant to the bumper arrangements 1 according to FIG. 2A, FIG. 2B, FIG. 3A, and FIG. 3B. In this case, the main cross member 2 and the auxiliary cross member 3 are each connected to one another via only one web 7. The web 7 is arranged in an outer end portion 5 relative to the motor vehicle transverse direction Y. According to the sectional views in FIG. 4B, a closing plate 12 is furthermore formed in the region of the main cross member 2. The closing plate 12 extends substantially over the entire width of the main cross member 2, over approx. 95%. Furthermore represented is a closing plate 12 in the region of the auxiliary cross member 3, which extends over approx. 20-50% of the width of the auxiliary cross member.

Unlike the previous embodiments, this design variant does not have a ring-shaped, projecting end portion and only one pair of struts 7 arranged on the outside. The struts 7 are located near or directly below the crash boxes 4. Such a narrower arrangement is well suited for a rear bumper system.

A projection 5 and a ring-shaped region identified in FIG. 1 is not present here, so that this example is suitable as a rear bumper arrangement 1.

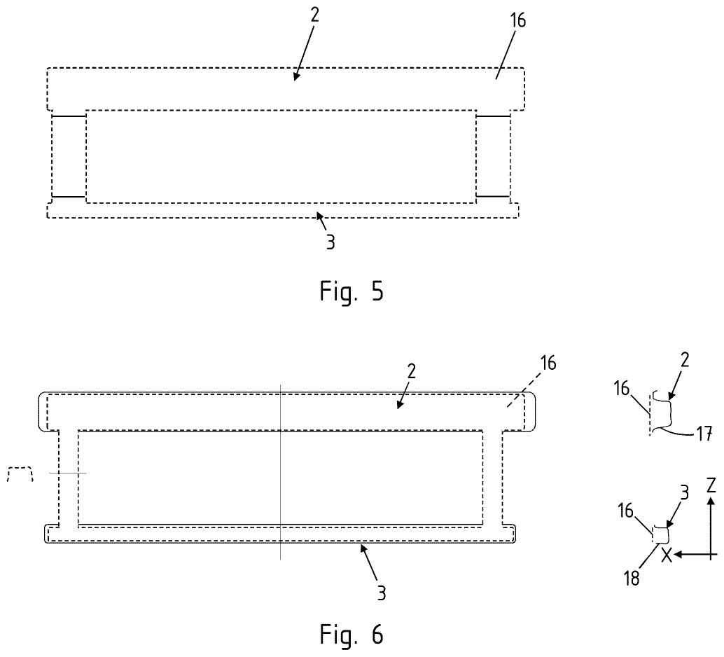

FIG. 5 and FIG. 6 show a front shell 16 formed from a front part of the main cross member 2, the webs 7 and a front part of the auxiliary cross member 3, which together are manufactured in one piece from a single butt-welded TWB blank. Here, a rear part 17—which is strongly profiled—of the main cross member 2 and a rear part 18—strongly profiled—of the auxiliary cross member 3 are each manufactured separately and joined with the front shell 16 from the TWB. The front shell 16 is manufactured by hot forming and press hardening.

Furthermore, a respective closing plate 12 is represented, which is arranged in front of the main cross member 2 and in front of the auxiliary cross member 3. The main cross member 2 and the auxiliary cross member 3 are each formed as a hollow profile or hat profile open on one side, wherein the opening is arranged towards the front in the motor vehicle longitudinal direction X.

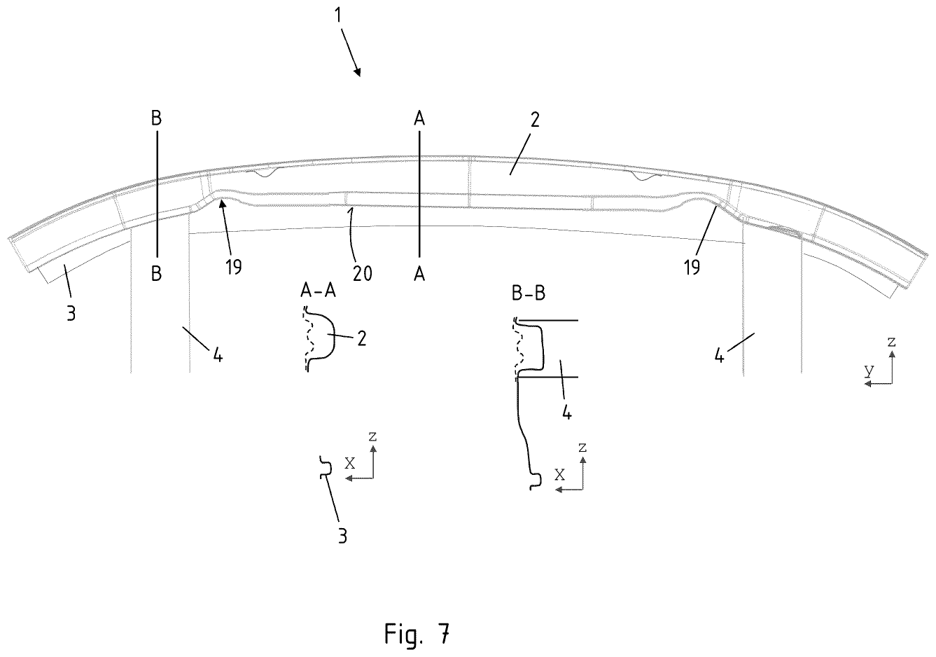

FIG. 7 shows an alternative design variant of the bumper arrangement 1 according to FIG. 6. Here, a respective trigger geometry, in the form of a bead 15, is formed in the flange of the hat profile in the region of the main cross member 2 between a center and the crash box attachments. The bead 15 can be located directly one above the other in both flanges in the motor vehicle vertical direction Z or also be provided only in the upper (or lower) flange. The bead 15 itself is then formed covered by the closing plate 12. Consequently, the bead 15 is manufactured during the press forming of the main cross member 2. Subsequently, it is covered by the closing plate 12. The closing plate 12 itself does not have a bead 15. Alternatively, it is possible that the closing plate 12 also has a bead 15.

The beads 15 serve, just like the rear wall concavity 19, for the targeted setting of the deformation behavior in certain crash scenarios, a central pole test and an RCAR bumper test. In the case of a bead 15 provided only on one flange side, this can interact synergistically with the rear wall concavity 19.

Alternatively, the rear wall concavity 19 from FIG. 7 can be omitted completely or be less pronounced, if the beads 15 are arranged in both flanges of the main cross member 2 on the front side.

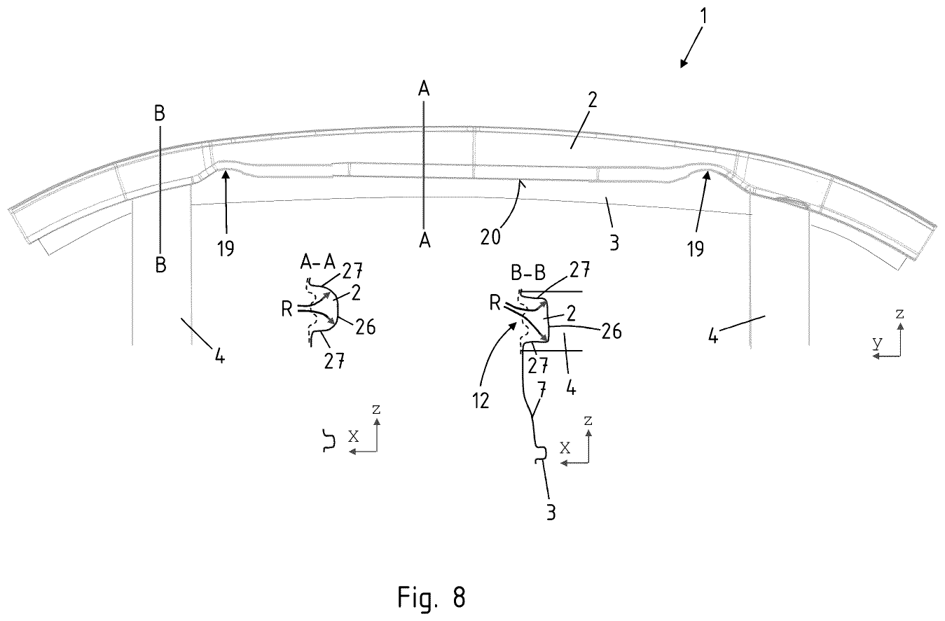

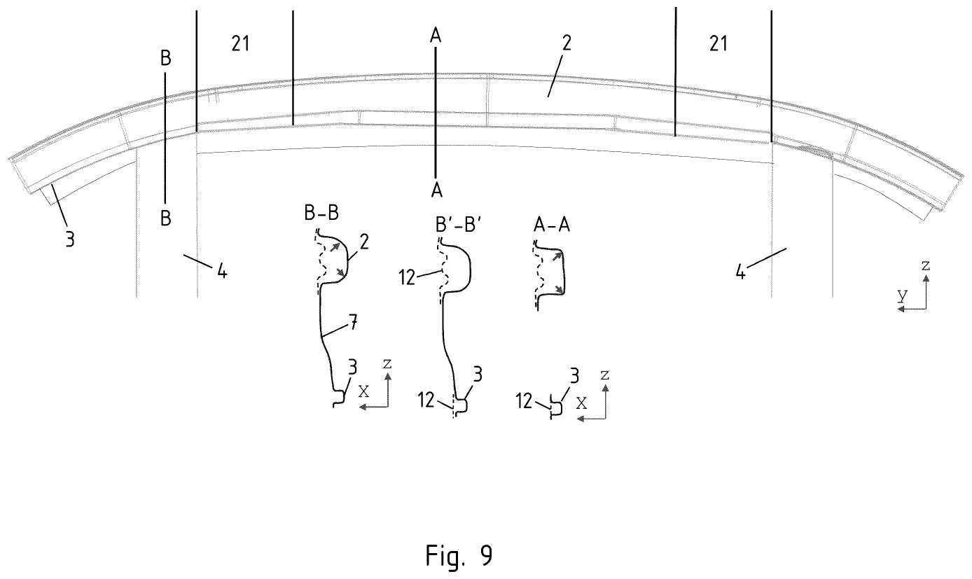

FIG. 8 shows a plan view of bumper arrangement 1 according to the present disclosure. In this case, the bumper arrangement 1 has a main cross member 2 as well as an auxiliary cross member 3 located underneath in the motor vehicle vertical direction Z. The main cross member 2 and the auxiliary cross member 3 are manufactured in one piece and of the same material from a tailor welded blank 8. On the front side 22, the main cross member 2 is closed with a closing plate 12. The closing plate 12 can extend over the entire width or length in the motor vehicle transverse direction Y. The closing plate 12 itself has two reinforcement beads, is thus formed W-shaped in its cross section. This can be seen from the sectional view A-A. On the rear side 20 of the main cross member 2, concavities 19 are formed according to the plan view. These concavities 19 are related to the cross section of the main cross member 2 as inwardly directed indentations. These indentations are located at a distance between the crash boxes 4. However, the indentations are located in a respectively outer region of the main cross member 2 and are thus removed from a center cross-sectional plane, not shown in detail, relative to the motor vehicle transverse direction Y. The main cross member 2 and the auxiliary cross member 3 are formed substantially as an open hat profile. Instead of the two beads, the closing plate can also have only one bead or can be of planar design. A soft zone as arranged in FIG. 9 can also be present.

FIG. 9 shows a plan view analogous to FIG. 8. Here, however, concavities 19 are not formed on the rear wall 20; rather, a longitudinal portion 21 relative to the motor vehicle transverse direction Y is formed as a so-called soft zone. Consequently, a tensile strength Rm is formed here below 1,200 MPa, below 1,000 MPa, greater than 500 MPa. The remaining region of the main cross member 2 then has a tensile strength Rm of greater than 1,350 MPa. The longitudinal portion 21 extends respectively between the crash boxes 4. The longitudinal portion 21 is formed approx. 5%-10% of the total length in the motor vehicle transverse direction Y of the main cross member 2. The longitudinal portion 21 with the respective soft zone is selected from an inner side of the crash box 4 relative to the motor vehicle transverse direction Y to a cross-sectional plane. Furthermore, three section lines A-A, B-B and B′-B′ are drawn in. These cross-sectional views are formed in the case of B-B analogous to FIG. 8. In the case of the section line B′-B′, a closing plate 12 is also arranged on the auxiliary cross member 3. The cross-sectional representation of A-A then also shows the closing plate 12 in the region of the auxiliary cross member 3. However, the closing plate 12 can also be omitted in the case of the auxiliary cross member 3. However, no trigger beads 15 are formed on the front side 22 or concavities 19 on the rear side 20 of the main cross member 2.

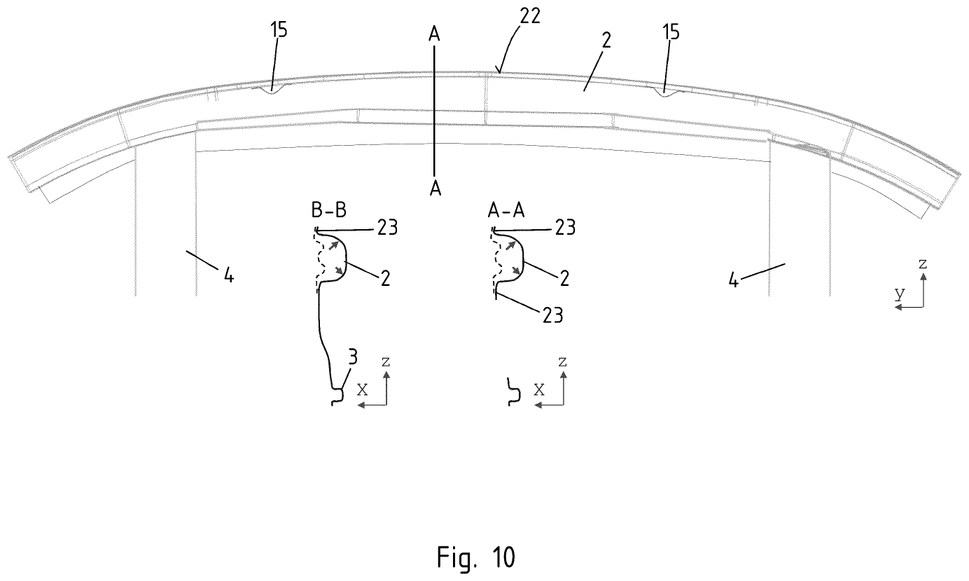

FIG. 10 shows an alternative design variant. In this case, two trigger beads 15 are formed on the front side 22 of the main cross member 2. However, these trigger beads 15 are formed only in the flange of the hat profile of the main cross member 2. The closing plate 12 for this purpose is itself formed continuous. Consequently, the closing plate 12 itself does not have any beads or trigger beads 15.

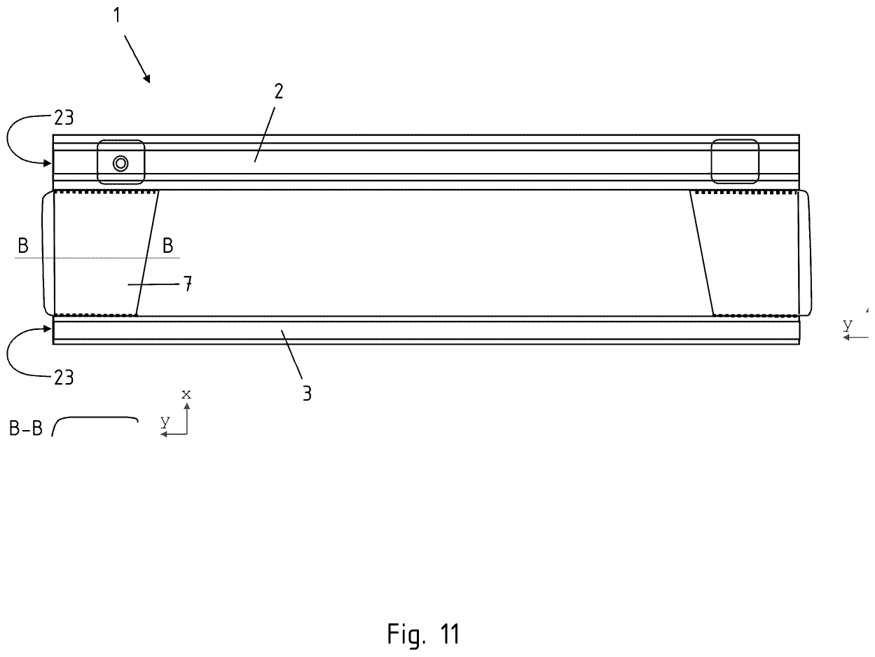

Furthermore, in FIG. 8-FIG. 10, in the cross-sectional views according to the section lines, radius arrows are drawn in the region of the main cross member 2. A respective radius arrow indicates the radius R which results in the transition between a rear web 26 of the main cross member 2 to the legs 27 respectively adjoining it. It can be easily seen that the radius R in the region of the crash box attachment 13 according to the section line B-B is formed smaller, so that a larger web 26 and thus a larger attachment area 13 for the crash box 4 results. In contrast, the radius R according to the section line A-A, i.e. in an region between the crash boxes 4, is larger. This results in a small web 26. The difference should be 50%-400%. Consequently, the radius R in the attachment portion 13 between the crash boxes 4 is 50%-80% larger than the radius R in the region of the crash box attachment 13. FIG. 11 shows a further end view of bumper arrangement 1. In this case, the web 7 connecting the main cross member 2 and the auxiliary cross member 3 is bent on an outer side relative to the motor vehicle transverse direction Y. This is shown in the cross-sectional view according to the line B-B. The bent section can project laterally beyond a respective end 23 of the main cross member 2 and the auxiliary cross member 3.

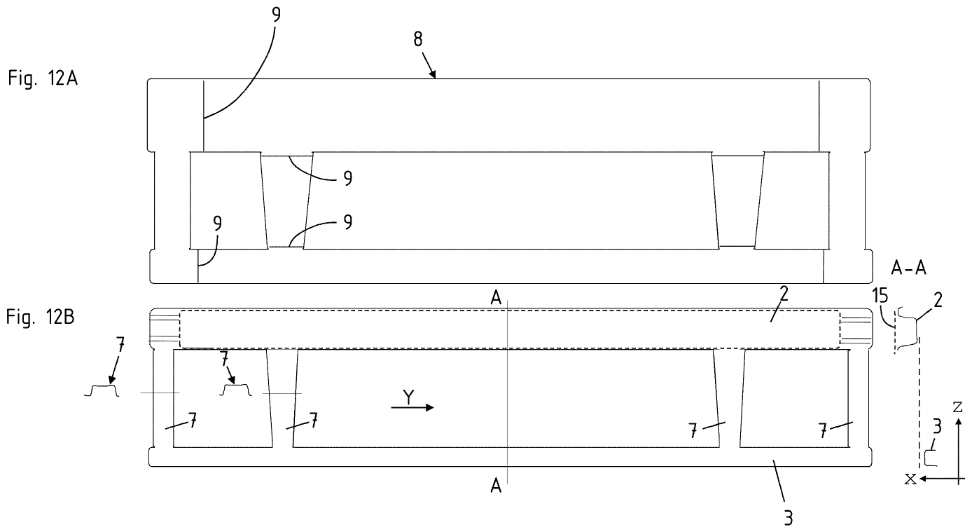

FIG. 12A and FIG. 12B again show an end view of an alternative design variant. FIG. 12A shows the blank 8 before the forming. The individual connection points are drawn in FIG. 12A, at each of which a butt joint is formed in order to manufacture the tailor welded blank 8 represented according to FIG. 12A.

The regions of the later webs 7 are each formed hat-shaped in their cross section according to the cross-sectional view directly adjacent in FIG. 12B. The inner web 7 relative to the motor vehicle transverse direction Y is formed conical, tapering downwards relative to the motor vehicle vertical direction Z. The main cross member 2 itself has a closing plate 12. Shown in the sectional representation A-A is an offset in the motor vehicle longitudinal direction X. Consequently, the auxiliary cross member 3 relative to the motor vehicle transverse direction Y is formed completely offset to the rear compared to the main cross member 2. A respective opening of the main cross member 2 and the auxiliary cross member 3 are formed in opposite directions to one another.

At this point, it is emphasized once again that all design variants described above and described below can each be used on their own and can be combined as desired with other design variants in this present disclosure, without departing from the subject matter of the present disclosure.

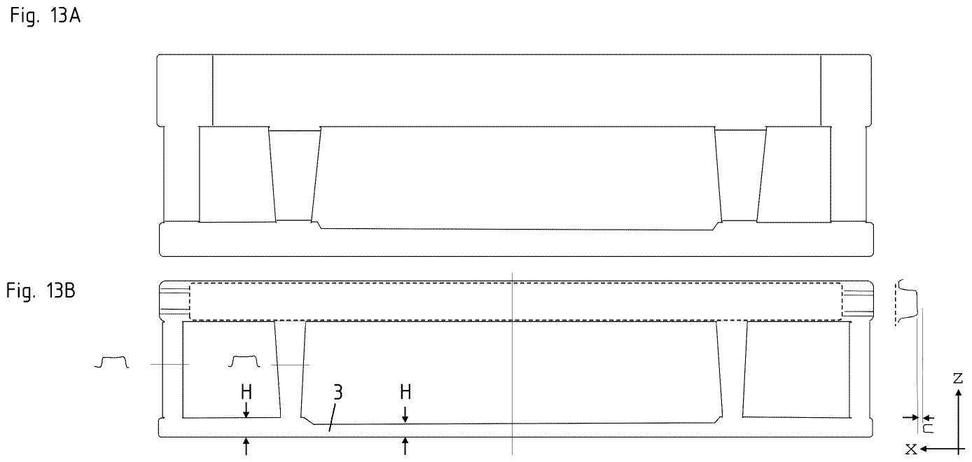

FIG. 13A and FIG. 13B show an analogous design variant to FIG. 12 and FIG. 12B. In this case, the height H of the auxiliary cross member 3 is formed reduced in a central section of the auxiliary cross member 3. The height is reduced by more than 10%, more than 20%, but not more than 50% in the motor vehicle vertical direction Z compared to an outer section of the auxiliary cross member 3.

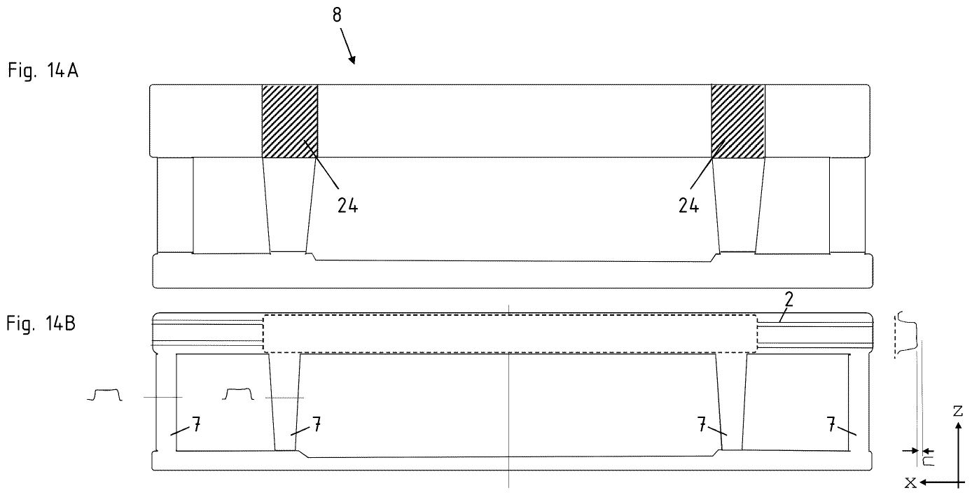

FIG. 14A and FIG. 14B show an analogous design variant to FIG. 12A and FIG. 12B. Here, an overlap 24 is formed in the region of the crash boxes 5 to be connected later. Consequently, the tailor welded blank 8 forms a double layer in this region. For example, one can be formed by the blank strip for manufacturing the later main cross member 2. A respective blank strip, which is used to form a later web 7, is then used overlapping and, as stated, a double layer of the blank 8 is formed in the region of the overlap 24. This is welded circumferentially at least at the edge in sections. A material reinforcement, material doubling, is thus formed in the region of the crash box attachment.

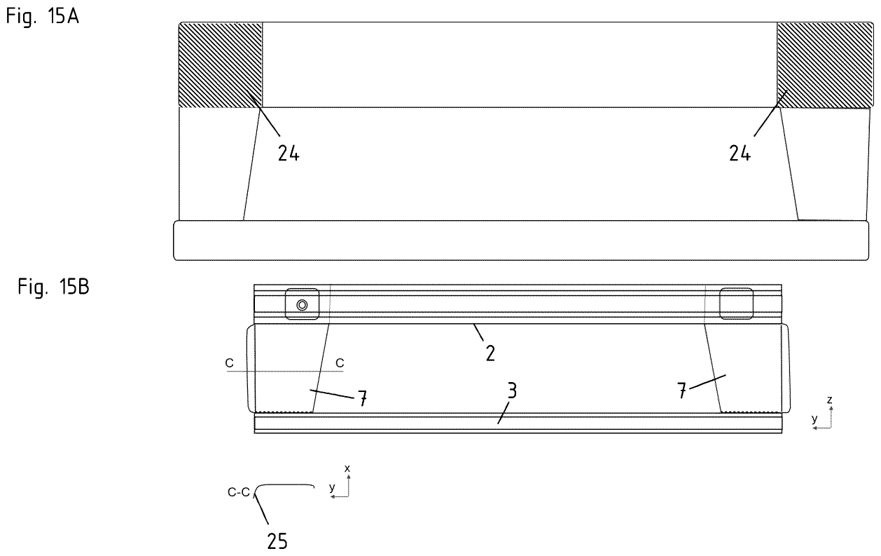

FIG. 15A and FIG. 15B show an alternative design variant. Here too, an overlap 24 is formed in the manufacture of the tailor welded blank 8. Here, the end portion and the crash box attachment zone are formed following one another in the same way. Here too, a double layer is formed for reinforcement.

Furthermore, according to the representation in FIG. 15B, the web 7 relative to the motor vehicle transverse direction Y is formed relatively wide. A bend 25 is directed to the rear relative to the motor vehicle longitudinal direction X. The main cross member 2 and the auxiliary cross member are formed with their respective opening pointing to the front relative to the motor vehicle longitudinal direction X. In this example, no closing plate 12 would be arranged.

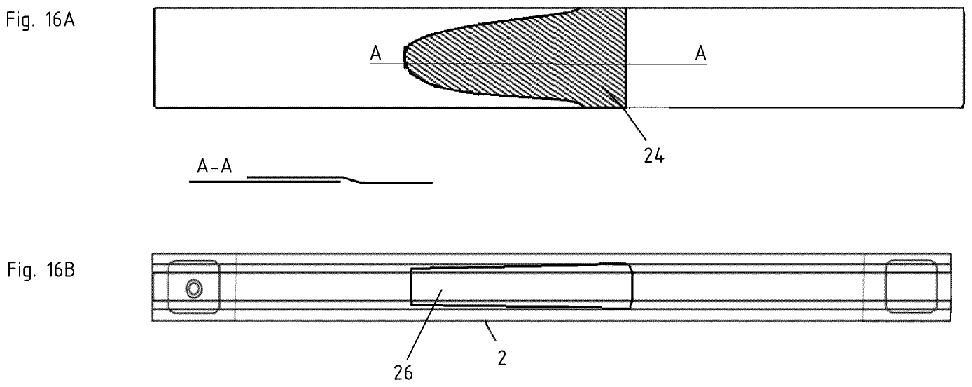

Finally, FIG. 16A and FIG. 16B shows an independent inventive thought, which can be combined with those features of the present disclosure and design variant described above, insofar as it relates to the steel material usable, the design of the rear side and front side with trigger beads, the arrangement of a soft zone or the different radii between rear side/rear wall and legs.

FIG. 16A and FIG. 16B show a main cross member 2, which can be connected via webs not shown to an auxiliary cross member not shown. This main cross member is manufactured from a tailor welded blank with two blanks from a steel material by hot forming and press hardening and is formed in cross section as a hollow profile open on one side and coupled to the motor vehicle, wherein the main cross member has a closing plate in sections and in its central longitudinal portion has a higher wall thickness by forming an overlap of the two blanks of the tailor welded blank. Due to the overlap in the center, a double sheet layer is formed as reinforcement and stiffening, which on the one hand effects an increased energy absorption capacity and on the other hand a reduced risk of cracking in the event of a central pole impact. The overlap 24 has a plurality of welding points by resistance spot welding or selective or stitched laser welding, which however are free of heat-affected zones due to the common hot forming and press hardening of the tailor welded blank, such as would be present in the case of subsequent welding of two separately manufactured cross member halves (left, right). The overlap is formed here predominantly only in the U-shaped section of the cross member, consequently on the rear side and legs projecting therefrom, and only to a small extent completely into the flanges. The overlap has a length of 200 mm to 500 mm, measured along the longitudinal extent of the cross member.

1-12. (canceled)

13. A bumper arrangement for a motor vehicle, comprising:
a main cross member; and
an auxiliary cross member arranged underneath the main cross member in a motor vehicle vertical direction, wherein
the main cross member and the auxiliary cross member each have a course curved around the motor vehicle vertical direction,
the main cross member and the auxiliary cross member are connected to one another via vertical webs,
the main cross member, the auxiliary cross member and the vertical webs are integral parts of a press formed tailor welded blank,
the main cross member and the auxiliary cross member each comprise, in cross section, a hollow profile open on one side,
the bumper arrangement is configured to be coupled to the motor vehicle via crash boxes,
the main cross member has a closing plate in sections, and
the bumper arrangement has at least one of different strengths or different wall thicknesses in sections.

14. The bumper arrangement according to claim 13, wherein the tailor welded blank comprises welded connection points each of which is formed at a butt joint.

15. The bumper arrangement according to claim 13, wherein the bumper arrangement has regions having a tensile strength Rm greater than 1,350 MPa, and remaining regions having the tensile strength less than 1,000 MPa.

16. The bumper arrangement according to claim 13, wherein
the vertical webs comprise four webs,
a first pair of two webs of the four webs are arranged in a region of the crash boxes, and
a second pair of two webs of the four webs are arranged in an outer end portion of the crash boxes, in a motor vehicle transverse direction.

17. The bumper arrangement according to claim 16, wherein, in the motor vehicle transverse direction, the main cross member comprises at least two weakenings between the crash boxes.

18. The bumper arrangement according to claim 17, wherein the weakenings comprise trigger beads which are on a rear side of the main cross member and are covered by the closing plate.

19. The bumper arrangement according to claim 13, wherein the closing plate is arranged on a front side of the main cross member in a motor vehicle longitudinal direction.

20. The bumper arrangement according to claim 13, wherein the auxiliary cross member is closed at least in sections by the closing plate.

21. The bumper arrangement according to claim 13, wherein the vertical webs are closed by the closing plate.

22. The bumper arrangement according to claim 13, wherein the closing plate extends over an entire length of the main cross member.

23. The bumper arrangement according to claim 13, wherein the tailor welded blank comprises at least at one connection point which is formed at an overlap joint in a region of a crash box attachment.

24. The bumper arrangement according to claim 13, wherein
the main cross member, in cross section of the hollow profile, has a radius between transition from the vertical webs to a leg of the hollow profile, and
the radius in an attachment portion of the crash boxes is smaller than in a region between the crash boxes.

25. The bumper arrangement according to claim 13, wherein the tailor welded blank comprises laser-welded connection points each of which is formed at a butt joint.

26. The bumper arrangement according to claim 13, wherein the bumper arrangement has regions having a tensile strength Rm greater than 1,500 MPa, and remaining regions having the tensile strength less than 1,000 MPa.

27. The bumper arrangement according to claim 16, wherein, in the motor vehicle transverse direction, the main cross member comprises, between the crash boxes, at least two trigger beads on at least one of a front side or a rear side of the main cross member.

28. The bumper arrangement according to claim 23, wherein an area of the overlap joint is more than 10 cm².
